(19) United States
(12) Patent Application Publication
(10) Pub. No.: US 2025/0371084 A1
(43) Pub. Date: Dec. 4, 2025

(54) SEO INFORMATION ACQUISITION SYSTEM, SEO INFORMATION ACQUISITION METHOD, AND INFORMATION STORAGE MEDIUM

(71) Applicant: Rakuten Group, Inc., Tokyo (JP)

(72) Inventors: Kazuhiro YOKOKAWA, Tokyo (JP); Yuto OIKAWA, Tokyo (JP); Yiyi PENG, Tokyo (JP)

(21) Appl. No.: 19/221,524

(22) Filed: May 29, 2025

(30) Foreign Application Priority Data
May 29, 2024 (JP) 2024-087021

(51) Int. Cl. G06F 16/951; G06F 16/953

(52) U.S. Cl. CPC G06F 16/951; G06F 16/953

(57) ABSTRACT

An SEO information acquisition system comprising at least one processor configured to: acquire a query used for a search in a predetermined service; acquire a related classification, the related classification being a classification used for a search in the predetermined service and being the classification related to the query; and acquire SEO information on SEO (Search Engine Optimization) of a search result page corresponding to the query in the predetermined service, based on the related classification.

### CROSS-REFERENCE TO RELATED APPLICATION

The present application claims priority from the Japanese patent application JP 2024-087021, filed on May 29, 2024, the disclosures of which are incorporated by reference herein.

### BACKGROUND OF THE INVENTION

### 1. Field of the Invention

The present disclosure relates to an SEO information acquisition system, an SEO information acquisition method, and an information storage medium.

### 2. Description of the Related Art

A technique called search engine optimization (SEO) for making a web page (web site) easier to search conventionally known. For example, JP2023-085427A describes a site creation support program with which a servicer providing a service performs a selection operation of selecting a query to be subjected to SEO measures for each web page and embeds a keyword or the like corresponding to the query in the corresponding web page, so as to obtain a higher-positioned display in search results of various search services.

### SUMMARY OF THE INVENTION

However, in the technique of JP2023-085427A, an operator needs to manually select a keyword or the like for the SEO measures, which accordingly takes time and effort of a servicer. This point is not limited to the technique of JP2023-085427A. The same applies to other conventional techniques in which a human manually takes SEO measures. Conventional techniques have not been able to make SEO measures sufficiently efficient.

One of the objects of the present disclosure is to make SEO measures more efficient.

An SEO information acquisition system according to the present disclosure includes: at least one processor configured to: acquire a query used for a search in a predetermined service; acquire a related classification, the related classification being a classification used for a search in the predetermined service and being the classification related to the query; and acquire SEO information on SEO (Search Engine Optimization) of a search result page corresponding to the query in the predetermined service, based on the related classification.

### DESCRIPTION OF THE DRAWINGS

FIG. 1 is a diagram showing an example of a hardware configuration of an SEO information acquisition system.

FIG. 2 is a diagram showing an example of a web page in an EC service.

FIG. 3 is a diagram showing an example of a web page in a search service.

FIG. 4 is a diagram showing an example of SEO information embedded in a search result page.

FIG. 5 is a diagram showing an example of functions realized in the SEO information acquisition system.

FIG. 6 is a diagram showing an example of an item database.

FIG. 7 is a diagram showing an example of a genre database.

FIG. 8 is a diagram showing an example of an attribute database.

FIG. 9 is a diagram showing an example of a search result database.

FIG. 10 is a diagram showing an example of an SEO information database.

FIG. 11 is a diagram showing an example of processing executed in the SEO information acquisition system.

FIG. 12 is a diagram showing an example of functions implemented in modifications of the present embodiment.

### DETAILED DESCRIPTION OF THE INVENTION

### 1. Hardware Configuration of SEO (Search Engine Optimization) Information Acquisition System

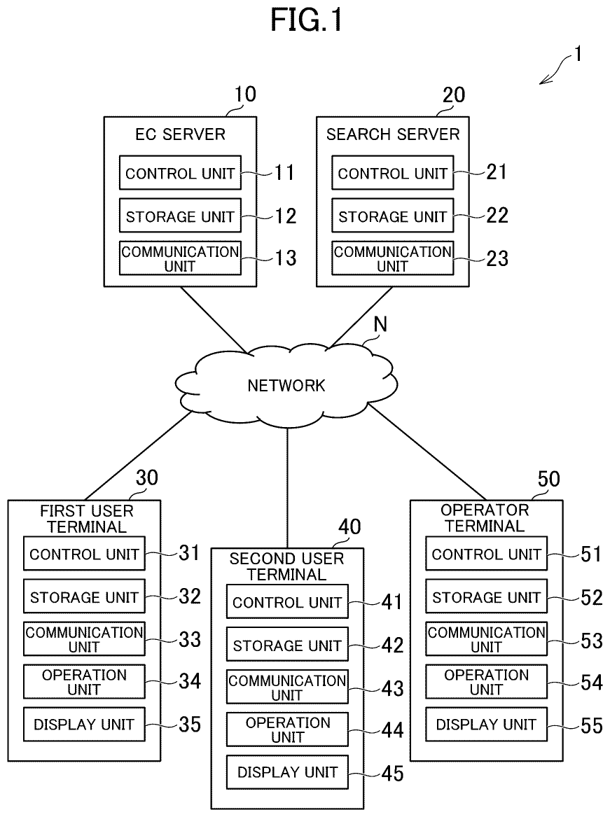

An example of an embodiment of an SEO information acquisition system, an SEO information acquisition method, and a program according to the present disclosure will be described. FIG. 1 is a diagram showing an example of a hardware configuration of the SEO information acquisition system. For example, in an SEO information acquisition system 1, each of an electronic commerce (EC) server 10, a search server 20, a first user terminal 30, a second user terminal 40, and an operator terminal 50 is connected to a network N such as the Internet or a LAN.

The EC server 10 is a server computer of an EC service. The EC service is an example of a predetermined service. Therefore, the description of the EC service may be read as a predetermined service. The predetermined service may be any service in which a search is executed, and is not limited to the EC service. For example, the predetermined service may be a travel reservation service, an online free market service, a reservation service of a facility such as a beauty salon or a restaurant, an electronic book service, a communication service, a financial service, a point management service, or other services.

For example, the EC server 10 includes a control unit 11, a storage unit 12, and a communication unit 13. The control unit 11 includes at least one processor. The storage unit 12 includes at least one of a volatile memory such as a RAM and a nonvolatile memory such as a flash memory. The communication unit 13 includes at least one of a communication interface for wired communication and a communication interface for wireless communication.

The search server 20 is a server computer of a search service. The search service is a service different from the EC service. A search of items is also executed in the EC service, but a search of various web pages, not limited to the EC service, is executed in the search service. In principle, a search of an item handled in the EC service is executed in the EC service. In the search service, a search is executed for an unspecified number of web pages of an unspecified number of services not limited to a specific service. For example, the search server 20 includes a control unit 21, a storage unit 22, and a communication unit 23. The hardware configurations of the control unit 21, the storage unit 22, and the communication unit 23 may be the same as those of the control unit 11, the storage unit 12, and the communication unit 13, respectively.

The first user terminal 30 is a computer of a first user who uses the EC service. The first user may also use the search service. For example, the first user terminal 30 is a smartphone, a tablet, a personal computer, or a wearable terminal. The first user terminal 30 includes a control unit 31, a storage unit 32, a communication unit 33, an operation unit 34, and a display unit 35. The hardware configurations of the control unit 31, the storage unit 32, and the communication unit 33 may be the same as those of the control unit 11, the storage unit 12, and the communication unit 13, respectively. The operation unit 34 is an input device such as a touch panel or a mouse. The display unit 35 is a display such as a liquid crystal display or an organic EL display.

The second user terminal 40 is a computer of a second user who uses the search service. The second user may also use the EC service. For example, the second user terminal 40 is a smartphone, a tablet, a personal computer, or a wearable terminal. The second user terminal 40 includes a control unit 41, a storage unit 42, a communication unit 43, an operation unit 44, and a display unit 45. The hardware configurations of the control unit 41, the storage unit 42, the communication unit 43, the operation unit 44, and the display unit 45 may be the same as those of the control unit 11, the storage unit 12, the communication unit 13, the operation unit 34, and the display unit 35, respectively.

The operator terminal 50 is a computer of an operator in the EC service. The operator terminal 50 is a smartphone, a tablet, a personal computer, or a wearable terminal. The operator terminal 50 includes a control unit 51, a storage unit 52, a communication unit 53, an operation unit 54, and a display unit 55. The hardware configurations of the control unit 51, the storage unit 52, the communication unit 53, the operation unit 54, and the display unit 55 may be the same as those of the control unit 11, the storage unit 12, the communication unit 13, the operation unit 34, and the display unit 35, respectively.

A program stored in the storage units 12, 22, 32, 42, and 52 may be supplied to the EC server 10, the search server 20, the first user terminal 30, the second user terminal 40, or the operator terminal 50 via the network N. Further, at least one of a reading unit (for example, a memory card slot) which reads a computer-readable information storage medium and an input/output unit (for example, a USB port) for inputting and outputting data to and from an external device may be included in the EC server 10, the search server 20, the first user terminal 30, the second user terminal 40, or the operator terminal 50. For example, a program stored in an information storage medium may be supplied to the EC server 10, the search server 20, the first user terminal 30, the second user terminal 40, or the operator terminal 50 via at least one of the reading unit and the input/output unit.

The SEO information acquisition system 1 may include at least one computer. The computer included in the SEO information acquisition system 1 is not limited to the example of FIG. 1. For example, the SEO information acquisition system 1 may include only the EC server 10 and the operator terminal 50. In this case, the search server 20, the first user terminal 30, and the second user terminal 40 exist outside the SEO information acquisition system 1. The SEO information acquisition system 1 may include only the operator terminal 50. In this case, the EC server 10, the search server 20, the first user terminal 30, and the second user terminal 40 exist outside the SEO information acquisition system 1. For example, the SEO information acquisition system 1 may include the operator terminal 50 and another computer not shown in FIG. 1.

### 2. Overview of SEO Information Acquisition System

In the present embodiment, the SEO information acquisition system 1 acquires SEO information related to SEO measures for a search result page in the EC service. The search result page in the EC service is a page indicating a search result of a search target (for example, an item, a service, or a web page indicating details thereof) in the EC service. The SEO is adjustment of a web page performed so that a predetermined web page is searched for at a higher position in a search result of a search engine. SEO may have the known meaning understood by those skilled in the art.

The SEO information is information prepared as SEO measures. The SEO information is one of components of a web page. Information used as the SEO information may be any information used for known SEO measures. For example, the SEO information may be a portion of a content displayed on a web page (for example, sentences, keywords, or other character strings), a title of a web page, a portion of a URL of a web page, metadata of a web page (for example, an HTML tag), a link of a web page, or a combination thereof.

In the present embodiment, there are two types of searches: a search executed in the EC service and a search executed in the search service. Although the SEO measures for a search executed in the EC service may be also taken, the SEO measures for a search executed in the search service will be mainly described in the present embodiment. For example, an operator of the EC service takes the SEO measures for causing a search result page of the EC service to be easily searched for in the search service.

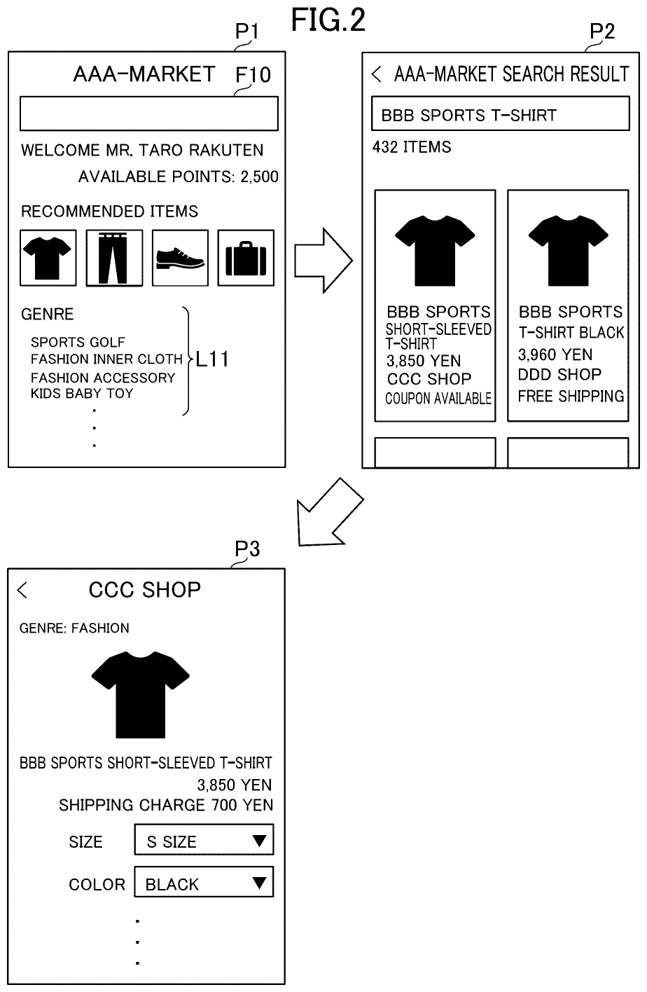

FIG. 2 is a diagram showing an example of a web page in the EC service. The present embodiment will describe a case where a web page is displayed on a browser, but the web page may be displayed on an application dedicated to the EC service or the search service. A web view in which a screen of a browser is embedded in a dedicated application may be used. Various known methods may be used for displaying a web page.

For example, when the first user operates the first user terminal 30 to access the EC server 10, the first user terminal 30 displays a top page P1 in the EC service on the display unit 35 as shown in the upper left of FIG. 2. The first user inputs a query into an input form F10 of the top page P1 in the EC service for a search in the EC service. The query is information which serves as a condition for the search. For example, the first user inputs at least one keyword as the query. The first user may search for an item by selecting a list L11 indicating a genre of the item. In this case, the genre is the query.

For example, when the first user inputs a query to execute a search in the EC service, a search engine in the EC service executes the search in the EC service based on the query inputted by the first user. The search may be executed by a known method. The search engine may also be a known search engine. As shown in the upper right of FIG. 2, the first user terminal 30 displays a search result page P2, indicating a search result in the EC service, on the display unit 35. In the example in the upper right of FIG. 2, a query “BBB sports T-shirt” is inputted and accordingly, items searched for based on the query are arranged in the search result page P2 in the EC service.

For example, when the first user selects an item from the search result page P2 in the EC service, the first user terminal 30 displays an item page P3 of the item on the display unit 35 as shown in the lower left of FIG. 2. The first user may perform an ordering procedure on the item page P3, or may return to the search result page P2 and select another item. The user may also return to the top page P1 in the EC service and enter another query to execute a search.

In the example in the lower left of FIG. 2, not only description and an image showing details of the item but also a genre, an attribute, and an attribute value of the item are displayed on the item page P3. The genre may also be referred to as a category. At least one of a plurality of genres prepared in the EC service is assigned to the item. For example, a person in charge of a store selling the item specifies the genre to be assigned to the item. The genre is used for the search in the EC service. For example, information indicating a rough classification of an item such as fashion, miscellaneous goods, toys, home appliances, food, or cosmetics is used as the genre. The genre can also be referred to as a kind of an item.

The attribute is information indicating a feature of an item. The attribute may also be referred to as information indicating a detailed classification of an item. For example, information indicating features of an item itself, such as a brand, manufacturer, size, color, function, material, shape, place of origin, state, taste, or target age of an item, is used as the attribute. The attribute value is a specific value of the attribute. The attribute value may also be referred to as a specific feature of the item. For example, a brand name, manufacturer name, specific size such as S, M, or L, specific color such as red, blue, or yellow, or other values of the item is used as the attribute value. The attribute and the attribute value are the same as the genre in the sense that these are information for classifying items from some point of view. However, the genre has a different meaning of classification from the attribute and the attribute value.

For example, the SEO measures may be taken for the item page P3, but in the present embodiment, a case where the SEO measures are taken for the search result page P2 in the EC service, not for the item page P3, will be described as an example. The operator of the EC service embeds SEO information in the search result page P2 so that the EC service will be searched for at the higher position than competitors' web pages in the search service. A search is executed based on the SEO information embedded in the search result page P2 in the search service. Competitors also take SEO measures. Therefore, it is important to set SEO information for facilitating a display at a higher position in the search service.

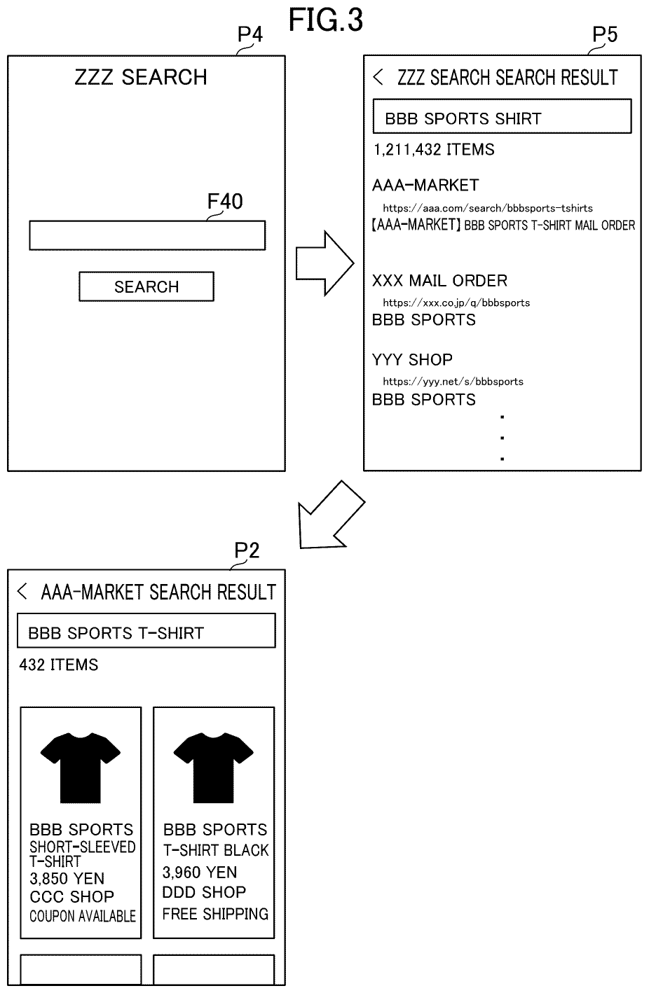

FIG. 3 is a diagram showing an example of a web page in the search service. For example, when the second user operates the second user terminal 40 to access the search server 20, the second user terminal 40 displays a top page P4 in the search service on the display unit 45 as shown in the upper left of FIG. 3. The second user inputs a query into an input form F40 of the top page P4 in the search service for a search in the search service.

For example, when the second user inputs the query to execute the search in the search service, a search engine in the search service executes the search in the search service based on the query inputted by the user. The search in the search service may also be executed by a known method. As shown in the upper right of FIG. 3, the second user terminal 40 displays a search result page P5, indicating a search result in the search service, on the display unit 45. In the example in the upper right of FIG. 3, a query “BBB sports shirt” (“shirt” instead of “T-shirt”) is inputted and accordingly, items searched for based on the query are arranged in the search result page P5 in the search service.

For example, the search result page P5 in the search service shows search results of web pages of various EC services. In the present embodiment, an operator of an EC service “AAA-Market” takes SEO measures with the aim of displaying the search result page P2 of the EC service “AAA-Market” at a higher position of the search result page P5 in the search service. For example, the operator executes a program stored in the operator terminal 50 and embeds appropriate SEO information in the search result page P2.

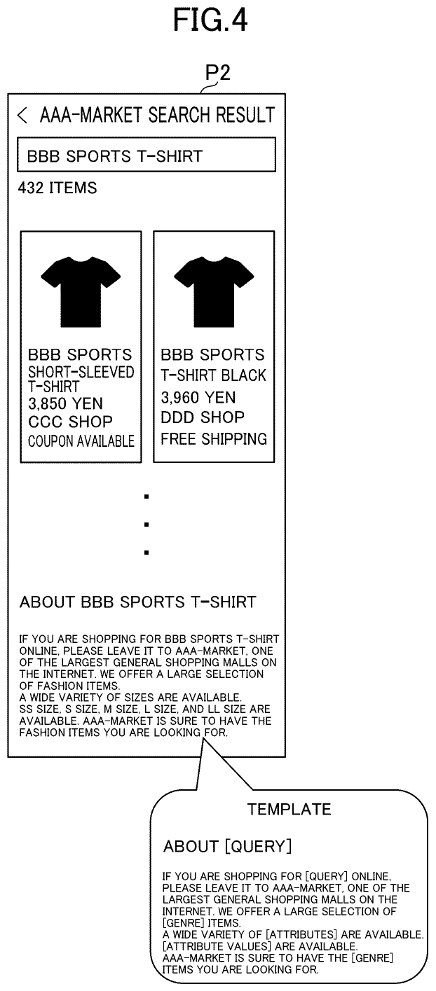

FIG. 4 is a diagram showing an example of SEO information embedded in the search result page P2. As shown in FIG. 4, the SEO information (in the example of FIG. 4, character strings “about BBB sports T-shirt” and the subsequent character strings) is embedded in the search result page P2 at an inconspicuous position such as the lowermost portion. The SEO information may be embedded in a manner to be invisible on the search result page P2 in the EC service. The SEO information embedded in the search result page P2 is referred to in the search in the search service.

In the present embodiment, the query, the genre, the attribute, and the attribute value are embedded in a template prepared in advance. In the example of the template of FIG. 4, the positions where these are to be embedded are specified by brackets. For example, the SEO information includes a query actually inputted in the EC service, and an appropriate genre (“fashion” in the example of FIG. 4), attribute (“size” in the example of FIG. 4), and attribute value (“SS size”, “S size”, “M size”, “L size”, and “LL size” in the example of FIG. 4) which correspond to the query. When the SEO information includes these pieces of information, the connection with the query inputted in the search service is sometimes increased. In this case, the search result page P2 in which the SEO information is embedded may be easily hit at the higher position in the search in the search service.

For example, when the accuracy of SEO information is high, the search result page P2 in the EC service is displayed at the higher position in the search result page P5 in the search service, as shown in the upper right of FIG. 3. When the second user selects a link L50 of the search result page P5 in the search service, the second user terminal 40 displays the search result page P2 indicating a search result based on the preset query “BBB sports shirt” on the display unit 45, as shown in the lower left of FIG. 3. Thus, the SEO information acquisition system 1 can guide the second user to the EC service. The same is true when the first user inputs the query in the search service.

As described above, the SEO information acquisition system 1 described as an example of the present embodiment acquires the SEO information including the genre, the attribute, and the attribute value corresponding to the query used in the EC service without the operator manually acquiring the SEO information. The SEO information includes these pieces of information, whereby the SEO information acquisition system 1 can display the search result page P2 in the EC service at a higher position in the search in the search service. Hereinafter, the SEO information acquisition system 1 will be described in detail.

### 3. Functions Implemented in SEO Information Acquisition System

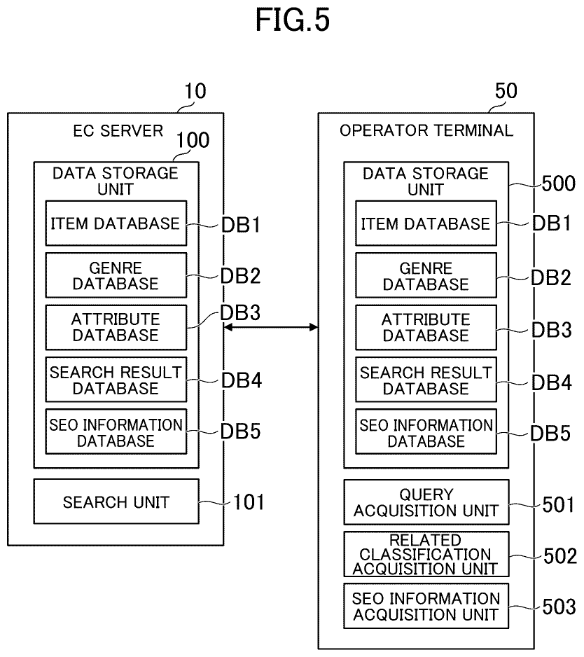

FIG. 5 is a diagram showing an example of functions implemented in the SEO information acquisition system 1. FIG. 5 shows functions of each of the EC server 10 and the operator terminal 50. The function of each of the search server 20, the first user terminal 30, and the second user terminal 40 may be the same as a known function.

### 3-1. Functions Realized in EC Server

For example, the EC server 10 includes a data storage unit 100 and a search unit 101. The data storage unit 100 is realized by the storage unit 12. The search unit 101 is realized by the control unit 11.

### [Data Storage Unit]

The data storage unit 100 stores data necessary for the EC service. For example, the data storage unit 100 stores an item database DB1, a genre database DB2, an attribute database DB3, a search result database DB4, and an SEO information database DB5.

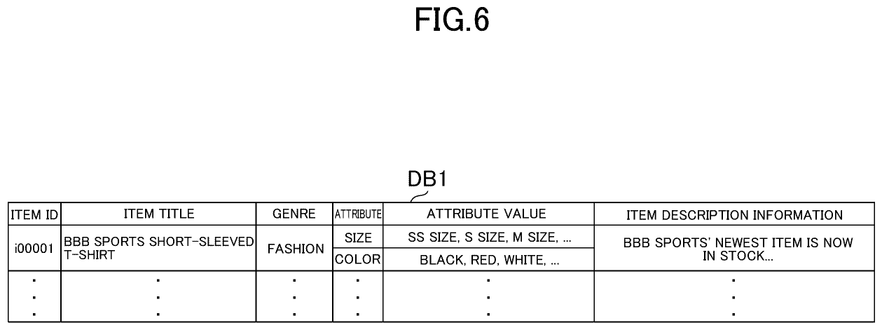

FIG. 6 is a diagram showing an example of the item database DB1. The item database DB1 is a database which stores various kinds of information related to items which are to be search targets in the EC service. For example, the item database DB1 stores item IDs, item titles, genres, attributes, attribute values, and item description information. Other information may be stored in the item database DB1. For example, the item database DB1 may store other information which can be an index in the search for the item. In the item database DB1, various kinds of information are registered by a store selling the item in the EC service.

An item ID is information which enables identification of an item. An item title is a character string indicating a title of the item. A Genre, an attribute, and an attribute value are used as an index of the item together with the item title. The item description information is at least one of a character string and an image indicating details of the item. The item description information is also used as the index of the item. For example, a person in charge of a store selling the item specifies the item title, the genre, the attribute, the attribute value, and the item description information. The item ID may be specified by the person in charge or may be automatically assigned.

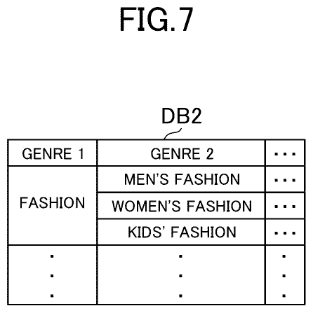

FIG. 7 is a diagram showing an example of the genre database DB2. The genre database DB2 is a database which stores genres used for searches in the EC service. For example, the genre database DB2 stores character strings indicating a plurality of genres in the EC service. At least one of the plurality of genres defined in the genre database DB2 is assigned to an item. In the example of FIG. 7, genres having a hierarchical structure are shown. The higher the hierarchy, the more general the genre. The lower the hierarchy, the more specific the genre. The hierarchical structure of the genre may be a structure adopted in a known EC service.

For example, “fashion”, which is a genre on the highest rank, includes “men's fashion”, “women's fashion”, and “kids' fashion” obtained by further subdividing the genre. The number of hierarchies of the genre may be three or more. It is assumed that hierarchical structures of the genres are also defined in the genre database DB2. However, the genre does not especially have to have the hierarchical structure. For example, a genre having no particular concepts of higher or lower rank may be defined in the genre database DB2. The genre database DB2 is managed by the operator or other party of an EC service.

When appropriate attributes are limited in a certain genre, the relationship between the genre and the attributes may be defined in the genre database DB2. For example, when there is a genre “television”, attributes such as “manufacturer”, “size”, “color”, and “function” are appropriate as information indicating features of television and therefore are associated with the genre “television”. On the other hand, attributes such as “taste”, “target age”, “material”, and “shape” are not appropriate as information indicating features of television and therefore are not associated with the genre “television”. As with the attribute, when appropriate attribute values are limited in a certain genre, the relationship between the genre and the attribute values may be defined in the genre database DB2.

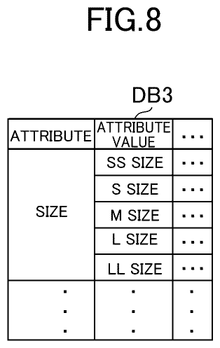

FIG. 8 is a diagram showing an example of the attribute database DB3. The attribute database DB3 is a database which stores at least one of attributes and attribute values in the EC service. For example, the attribute database DB3 stores each of a plurality of attributes and each of a plurality of attribute values belonging to the corresponding attribute. At least one of a plurality of attributes and attribute values defined in the attribute database DB3 is assigned to an item. Other information may be stored in the attribute database DB3. For example, when the attribute has a hierarchical structure, the hierarchy of each attribute may be defined in the attribute database DB3. The attribute database DB3 is managed by the operator or other party of the EC service.

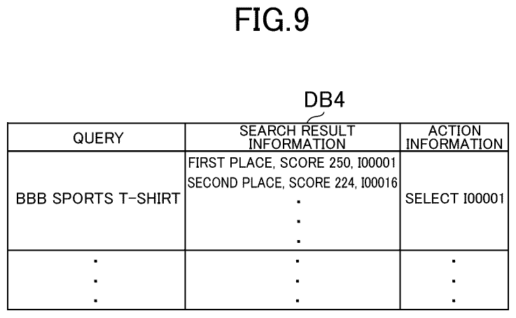

FIG. 9 is a diagram showing an example of the search result database DB4. The search result database DB4 is a database which stores various kinds of information related to search results in the EC service. For example, the search result database DB4 stores the query inputted in the EC service, search result information on a search result corresponding to the query, and action information on an action after the input of the query. Other information may be stored in the search result database DB4. For example, the search result database DB4 may store search date and time at which a search corresponding to the query is executed.

For example, when the query is inputted in the EC service, the EC server 10 stores the query in the search result database DB4. The search unit 101 described later inputs the query into the search engine, acquires the search result information based on a processing result of the search engine, and stores the search result information in the search result database DB4. The search result information indicates contents of the search result page P2. For example, the search result information may indicate the item ID of the item which is a search target, and a score (an index indicating a degree of match with the query) calculated by the search engine.

For example, when the EC server 10 receives operation content data indicating an operation content for the search result page P2 in the EC service from the first user terminal 30, the EC server 10 generates action information corresponding to the operation content data and stores the action information in the search result database DB4. The action information indicates an action of the first user on the search result page P2. For example, the action information may indicate an item selected on the search result page P2, an item selected and bookmarked on the search result page P2, or an item ordered from the search result page P2.

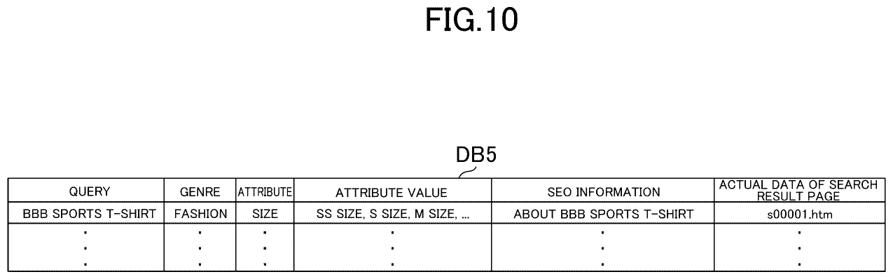

FIG. 10 is a diagram showing an example of the SEO information database DB5. The SEO information database DB5 is a database which stores various kinds of information related to SEO information of the search result page P2. For example, the SEO information database DB5 stores actual data of a query, a genre, an attribute, an attribute value, SEO information, and the search result page P2. These pieces of information are stored in the SEO information database DB5 through processing by the operator terminal 50 described later. Other information may be stored in the SEO information database DB5. For example, the SEO information database DB5 may store acquisition date and time at which the SEO information is acquired and a URL corresponding to the search result page P2. A query corresponding to the search result page P2 may be indicated as an argument of the URL.

Data stored in the data storage unit 100 is not limited to the above-described example. The data storage unit 100 may store data necessary for the EC service. For example, the data storage unit 100 may store a user database which stores various kinds of information related to users who use the EC service. The data storage unit 100 may store the actual data of the search result page P2 for which the SEO measures are taken by an SEO information acquisition unit 503 described later in a place other than the SEO information database DB5. The actual data may be in any form, for example, in HTML form. The actual data of the search result page P2 includes SEO information. The SEO information stored in the data storage unit 100 may be referred to in a search in the search service.

### [Search Unit]

The search unit 101 executes the search in the EC service based on the query inputted in the EC service. The search unit 101 may execute the search based on the item database DB1 and a known search engine. For example, the search unit 101 executes the search by the search engine based on the query inputted in the EC service and the index of each item stored in the item database DB1. The search engine may be stored in the data storage unit 100 or may be stored in a computer other than the EC server 10. The search unit 101 causes the first user terminal 30 to display the search result page P2 indicating a search result outputted by the search engine.

For example, the search unit 101 stores the query, which is inputted in the EC service, in the search result database DB4. The search unit 101 stores search result information indicating a processing result of the search engine in the search result database DB4 in a manner to associate the search result information with a corresponding query. When operation content data indicating an action on the search result page P2 is acquired, the search unit 101 stores action information indicating an action corresponding to the operation content data in the search result database DB4 in a manner to associate the action information with a corresponding query. The search unit 101 can execute other processing necessary for the search in the EC service. The other processing may be known processing.

### 3-2. Functions Realized in Operator Terminal

For example, the operator terminal 50 includes a data storage unit 500, a query acquisition unit 501, a related classification acquisition unit 502, and the SEO information acquisition unit 503. The data storage unit 500 is realized by the storage unit 52. The query acquisition unit 501, the related classification acquisition unit 502, and the SEO information acquisition unit 503 are realized by the control unit 51.

### [Data Storage Unit]

The data storage unit 500 stores data necessary for acquiring SEO information. For example, the data storage unit 500 stores the item database DB1, the genre database DB2, the attribute database DB3, the search result database DB4, and the SEO information database DB5. These databases may be the same as those stored in the data storage unit 100 of the EC server 10. The operator terminal 50 downloads these databases from the EC server 10 and records the databases in the data storage unit 500.

The data storage unit 500 may store data necessary for acquiring SEO information. For example, the data storage unit 500 may store a template of SEO information. In the present embodiment, a case where the template is common to all the genres is exemplified, but the template may be prepared for each genre as in modifications described later.

### [Query Acquisition Unit]

The query acquisition unit 501 acquires the query used for the search in the EC service. The present embodiment exemplifies a case where the query acquisition unit 501 acquires the query actually used for the search in the EC service (the query actually inputted by the first user who uses the EC service), but the query not actually used for the search in the EC service (for example, a query thought up by an operator) may be acquired. The query may be in any form, and may include at least one keyword, or may be a sentence, for example. The query acquisition unit 501 stores the acquired query in the SEO information database DB5.

In the present embodiment, the queries are stored in the search result database DB4 and therefore, the query acquisition unit 501 acquires at least one query from the search result database DB4. The query acquisition unit 501 may acquire only one query or may acquire a plurality of queries. The number of queries acquired by the query acquisition unit 501 may be determined in advance. For example, the query acquisition unit 501 may acquire queries for a predetermined latest period (for example, most recent one month) or queries for all periods from the search result database DB4. The query acquisition unit 501 may acquire the query selected at random from the search result database DB4.

Here, when the queries are stored in a database other than the search result database DB4, the query acquisition unit 501 may acquire queries from the other database. When queries are stored in a computer other than the operator terminal 50 (for example, the EC server 10 or the first user terminal 30) or an external information storage medium, the query acquisition unit 501 may acquire queries from the other computer or the external information storage medium.

### [Related Classification Acquisition Unit]

The related classification acquisition unit 502 acquires a related classification which is a classification used for the search in the EC service and is the classification related to the query. The classification is assigned to the search target in the search. The items are the search targets in the EC service and therefore, the classification is assigned to the item. When other search targets such as services or contents are searched for, the classification is assigned to the other search targets. The classification is information which can be an index. A plurality of classifications are prepared in advance, and at least one of the plurality of classifications is assigned to the search target. The related classification acquisition unit 502 may acquire at least one related classification. The related classification acquisition unit 502 may acquire only one related classification or may acquire a plurality of related classifications. The related classification acquisition unit 502 stores the acquired related classification in the SEO information database DB5.

In the present embodiment, a combination of the genre, the attribute, and the attribute value corresponds to the classification. Therefore, parts describing the combination can be read as the classification. The classification may be any one or two of the genre, the attribute, and the attribute value. That is, each of the following aspects is within the scope of the present disclosure: an aspect in which only the genre corresponds to the classification; an aspect in which only the attribute corresponds to the classification; an aspect in which only the attribute value corresponds to the classification; an aspect in which a combination of the genre and the attribute corresponds to the classification; an aspect in which a combination of the genre and the attribute value corresponds to the classification; and an aspect in which a combination of the attribute and the attribute value corresponds to the classification. The classification may be information called by a name other than the genre, the attribute, and the attribute value. For example, information called a category or a division may correspond to a classification.

For example, the related classification acquisition unit 502 acquires, based on the query acquired by the query acquisition unit 501, a combination of the genre, the attribute, and the attribute value appropriate as the SEO information of the search result page P2 corresponding to the query, as the related classification. Related classification data indicating a relationship between the query and a combination of an appropriate genre, attribute, and attribute value may be stored in the data storage unit 100 in advance. The related classification data may be in any form, for example, in a table form, in a formula form, part of a machine learning model, or part of a program.

For example, in the example of FIG. 2, the query “BBB sports T-shirt” and the genre “fashion” appropriate for the query are associated with related classification data in advance. Similarly, the query “BBB sports T-shirt” and the attribute and attribute value appropriate for the query are associated with related classification data in advance. These associations may be specified by an operator, may be determined by analyzing an action in the EC service as in a third modification described later, or may be determined in accordance with a processing result of the search engine in the EC service as in a fourth modification described later.

In the present embodiment, it is assumed that the operator specifies combinations of genres, attributes, and attribute values appropriate for various queries and creates related classification data in advance. The related classification acquisition unit 502 acquires a combination of the genre, the attribute, and the attribute value associated with the query, acquired by the query acquisition unit 501, as the related classification based on the query and related classification data created in advance. The related classification acquisition unit 502 may identify the query, which is similar to the query acquired by the query acquisition unit 501, among queries stored in the related classification data and acquire a combination of the genre, the attribute, and the attribute value associated with the identified query, as the related classification. A state in which queries are similar is a state in which the meanings thereof in natural language are similar. For example, a state in which the wordings of queries partially match or a state in which a difference between vectors indicating the meanings of queries is less than a threshold value corresponds to the state in which queries are similar.

### [SEO Information Acquisition Unit]

The SEO information acquisition unit 503 acquires SEO information on SEO of the search result page P2 corresponding to the query in the EC service, based on the related classification acquired by the related classification acquisition unit 502. The SEO information is not stored somewhere in advance and therefore, generation of SEO information by the SEO information acquisition unit 503 corresponds to acquisition of the SEO information by the SEO information acquisition unit 503.

The search result page P2 corresponding to the query is a web page indicating a result of a search executed based on the query. The search result page P2 corresponding to the query can also be referred to as a web page indicating a processing result of the search engine into which the query is inputted. The search result page P2 corresponding to the query shows a search target hit in a search. The SEO information of the search result page P2 is SEO information embedded in the search result page P2.

For example, the SEO information acquisition unit 503 may acquire the related classification itself as the SEO information. The SEO information acquisition unit 503 may acquire the SEO information by embedding the related classification in the template of the SEO information prepared in advance. The SEO information acquisition unit 503 may input the related classification a into generation artificial intelligence (AI) such as a large-scale language model and acquire a text generated by the generation AI as the SEO information.

For example, the SEO information acquisition unit 503 stores the query acquired by the query acquisition unit 501, the related classification (for example, a combination of the genre, the attribute, and the attribute value) acquired by the related classification acquisition unit 502, and the SEO information, and actual data of the search result page P2 in the SEO information database DB5 in a manner to associate the query, the related classification, and the SEO information with the actual data. The SEO information acquisition unit 503 embeds the SEO information in the actual data of the search result page P2. The query may be embedded in the search result page P2.

It is assumed that actual data to be the format of the search result page P2 is stored in the data storage unit 500. The SEO information acquisition unit 503 acquires the actual data of the search result page P2 by embedding SEO information in the actual data to be the format. The SEO information acquisition unit 503 may embed the query, the genre, the attribute, and the attribute value as the SEO information like a keyword without using any template.

For example, the SEO information acquisition unit 503 acquires the SEO information for various queries based on the related classifications of corresponding queries and stores the SEO information in the SEO information database DB5. After updating the SEO information database DB5, the SEO information acquisition unit 503 uploads the SEO information database DB5 to the EC server 10. The SEO information database DB5 uploaded to the EC server 10 is referred to in the search in the search service. The SEO information database DB5 uploaded to a computer other than the EC server 10 may be referred to in the search in the search service. Further, only the SEO information in the SEO information database DB5 may be uploaded and referred to in the search in the search service.

### 4. Processing Executed in SEO Information Acquisition System

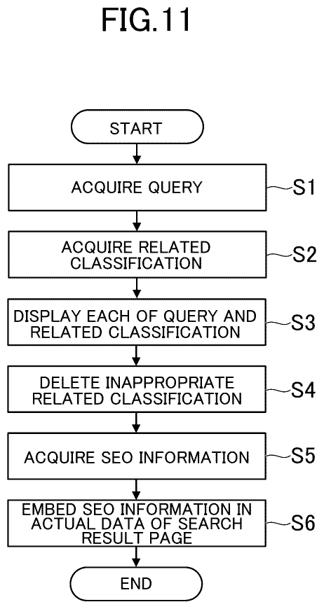

FIG. 11 is a diagram showing an example of processing executed in the SEO information acquisition system 1. Among the processing executed in the SEO information acquisition system 1, processing executed in the operator terminal 50 will be described in the present embodiment. The control unit 51 executes the program stored in the storage unit 52, and thus the processing of FIG. 11 is executed.

As shown in FIG. 11, the control unit 51 acquires the query stored in the search result database DB4 (S1). The control unit 51 acquires a combination of the genre, the attribute, and the attribute value associated with the query acquired in S1 as the related classification, based on the related classification data prepared in advance (S2). The control unit 51 causes the display unit 55 to display each of the query and the related classification (S3). The control unit 51 deletes an inappropriate related classification based on an operation by the operator (S4). In the example of FIG. 11, a case where final confirmation is performed by the operator through the processing of S3 and S4 is exemplified, but the processing of S3 and S4 do not have to be executed.

The control unit 51 acquires SEO information by embedding the related classification in the template of the search result page P2 (S5). In S5, the control unit 51 also embeds the query in the template of the search result page P2. The control unit 51 embeds the SEO information acquired in S5 in the actual data of the search result page P2 corresponding to the query (S6), and the present processing is ended. When the processing of S6 is executed, the operator terminal 50 uploads the SEO information database DB5 to the EC server 10 or another computer, and the SEO information is referred to in a search in the search service.

### 5. Summary of Embodiment

The SEO information acquisition system 1 of the present embodiment acquires the query used for the search in the EC service. The SEO information acquisition system 1 acquires the related classification which is the classification used for the search in the EC service and is the classification related to the query. The SEO information acquisition system 1 acquires the SEO information of the search result page corresponding to the query in the EC service based on the related classification. This eliminates the need for the operator to manually generate SEO information, and thus the SEO information acquisition system 1 can make the SEO measures more efficient. The SEO information acquisition system 1 can reduce a burden on the operator. For example, the search engine in the search service searches for the search result page P2 in the EC service based on the SEO information corresponding to the related classification. The search is executed based on an appropriate index and therefore, the search result page P2 in the EC service can be displayed at a relatively higher position in the search result page P5 in the search service.

### 6. Modifications

The present disclosure is not limited to the embodiment described above. The present disclosure can be appropriately modified without departing from the gist of the present disclosure.

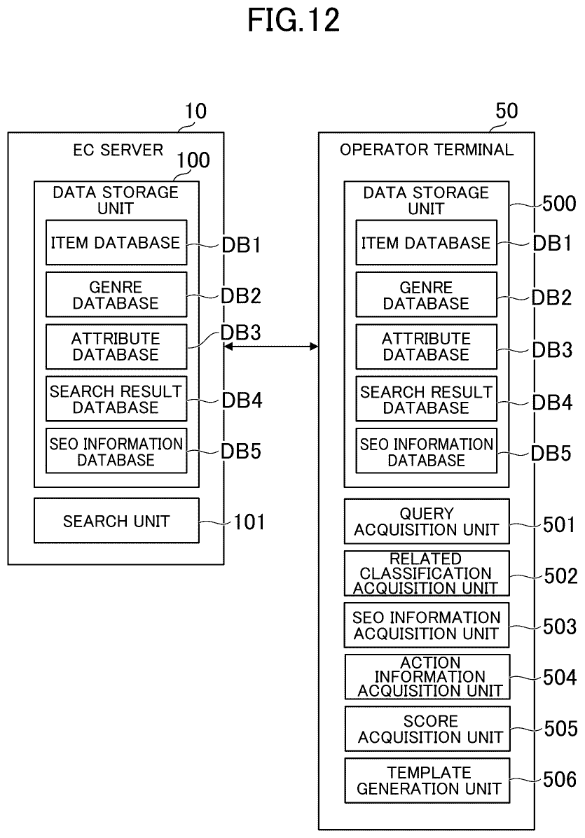

FIG. 12 is a diagram showing an example of functions implemented in the modifications. For example, the operator terminal 50 includes an action information acquisition unit 504, a score acquisition unit 505, and a template generation unit 506. Each of the action information acquisition unit 504, the score acquisition unit 505, and the template generation unit 506 is realized by the control unit 11.

### 6-1. First Modification

For example, the query acquisition unit 501 may acquire queries whose number of searches in an EC service is relatively large. The number of searches is the number of times the query is used in a search. The query acquisition unit 501 of a first modification aggregates the number of searches for each query based on the search result database DB4. The query acquisition unit 501 may set all past periods as a calculation target of the number of searches, or may set only a predetermined latest period (for example, most recent one month) as the calculation target of the number of searches. Search dates and times are assumed to be stored in the search result database DB4. In the aggregation of the number of searches, a complete match of the queries may be required, or queries which partially match each other may be grouped together.

For example, the query acquisition unit 501 acquires queries ranked in the top n (n is a natural number) of the number of searches as the queries whose number of searches is relatively large, among a plurality of queries whose number of searches has been calculated. The query acquisition unit 501 does not acquire queries whose number of searches is less than the top n (n is a natural number) among the plurality of queries whose number of searches has been calculated because the queries are the queries whose number of searches is relatively small. The query acquisition unit 501 may acquire queries whose number of searches is equal to or larger than a threshold value as the queries whose number of searches is relatively large from among the plurality of queries whose number of searches has been calculated. The query acquisition unit 501 is allowed not to acquire queries whose number of searches is less than the threshold value from among the plurality of queries whose number of searches has been calculated because the queries are the queries whose number of searches is relatively small.

Different from the embodiment in that a related classification and SEO information are acquired for the queries whose number of searches is relatively large, the processing itself of each of the related classification acquisition unit 502 and the SEO information acquisition unit 503 may be the same as that the embodiment. The related classification acquisition unit 502 acquires the related classification which is related to the queries whose number of searches is relatively large. The related classification acquisition unit 502 does not acquire the related classification which is related to the queries whose number of searches is relatively small. The SEO information acquisition unit 503 acquires the SEO information of the search result page P2 corresponding to the queries whose number of searches is relatively large. The SEO information acquisition unit 503 does not acquire the SEO information of the search result page P2 corresponding to the queries whose number of searches is relatively small.

The SEO information acquisition system 1 of the first modification acquires the queries whose number of searches in the EC service is relatively large. Thus, the SEO information acquisition system 1 acquires the SEO information of the search result page P2 corresponding to queries which are frequently used in the search in the EC service, being able to make the SEO measures more efficient. For example, there is a possibility that the queries whose number of searches in the EC service is relatively small are not inputted so often even in the search service and therefore, the SEO information acquisition system 1 does not acquire the SEO information for such queries. Accordingly, it is possible to prevent SEO information which is not very useful from being acquired.

### 6-2. Second Modification

For example, a search in an EC service is repeatedly executed and accordingly, the trend of a query at that time may change with the elapse of time. Therefore, in order that the SEO information acquisition system 1 can keep up with the latest trend, in the SEO information acquisition system 1, the processing of each of the query acquisition unit 501, the related classification acquisition unit 502, and the SEO information acquisition unit 503 may be executed at the acquisition timing which repeatedly arrives. Here, the operator terminal 50 is assumed to acquire the latest item database DB1, genre database DB2, attribute database DB3, search result database DB4, and SEO information database DB5 from the EC server 10 and record these in the data storage unit 500.

The acquisition timing is a timing at which the processing of each of the query acquisition unit 501, the related classification acquisition unit 502, and the SEO information acquisition unit 503 is executed. In a second modification, a case where the acquisition timing periodically arrives is described as an example, but the acquisition timing may irregularly arrive. When the acquisition timing periodically arrives, data (for example, a batch file) indicating a time interval between the acquisition timings is assumed to be stored in the data storage unit 500. The time interval between the acquisition timings may be any length. For example, the time interval between the acquisition timings may be one week, one month, two months, or half a year.

For example, the operator terminal 50 acquires current date and time using a real-time clock, a GPS, or the like. The operator terminal 50 determines whether or not the acquisition timing has arrived by determining whether or not the current date and time is the acquisition timing. When the acquisition timing arrives irregularly, the operator terminal 50 may determine whether or not the acquisition timing has arrived by determining whether or not an operator has performed an operation to instruct execution of the processing of each of the query acquisition unit 501, the related classification acquisition unit 502, and the SEO information acquisition unit 503 through the operation unit 54. The operator terminal 50 may determine whether or not the acquisition timing has arrived by determining whether or not a predetermined number or more of new queries have been accumulated, based on the search result database DB4.

For example, when a certain acquisition timing (the latest acquisition timing) has arrived, the query acquisition unit 501 does not acquire the query which has been acquired at least at the previous acquisition timing but acquires the query which has not been acquired at least at the previous acquisition timing. The previous acquisition timing is the most recent acquisition timing. At least the previous acquisition timing may be only the previous acquisition timing or may be the previous acquisition timing and an acquisition timing before the previous acquisition timing. Different from the embodiment in that the query acquisition unit 501 acquires the query at which timing, the processing of acquiring the query by the query acquisition unit 501 is the same as that in the embodiment. In the second modification, the acquisition timing is assumed to be stored in the SEO information database DB5. The query, genre, attribute, attribute value, and SEO information acquired at which timing are assumed to be identified based on the acquisition timing stored in the SEO information database DB5.

For example, when a certain acquisition timing has arrived, the related classification acquisition unit 502 does not acquire the related classification of the query whose related classification has been acquired at least at the previous acquisition timing but acquires the related classification of the query whose related classification has not been acquired at least at the previous acquisition timing. Different from the embodiment in that the related classification acquisition unit 502 acquires the related classification related to the query at which timing, the processing of acquiring the related classification by the related classification acquisition unit 502 is the same as that in the embodiment.

When a certain acquisition timing has arrived, the SEO information acquisition unit 503 of the second modification does not acquire e the SEO information of the query whose SEO information has been acquired at least at the previous acquisition timing but acquires the SEO information of the query whose SEO information has not been acquired at least at the previous acquisition timing. For example, the SEO information acquisition unit 503 acquires the SEO information of the search result page P2 corresponding to the query which has not been acquired at least at the previous acquisition timing, based on the related classification which has not been acquired at least at the previous acquisition timing. Different from the embodiment in that the SEO information acquisition unit 503 acquires the SEO information of the search result page P2 corresponding to the query at which timing based on the related classification related to the query at which timing, the processing of acquiring the SEO information by the SEO information acquisition unit 503 is the same as that in the embodiment.

When a certain acquisition timing has arrived, the SEO information acquisition system 1 of the second modification does not acquire the SEO information of the query whose SEO information has been acquired at least at the previous acquisition timing but acquires the SEO information of the query whose SEO information has not been acquired at least at the previous acquisition timing. Accordingly, the SEO information acquisition system 1 can prevent acquisition of similar SEO information for a query for which SEO information has been generated in the past, thereby being able to prevent generation of unnecessary SEO information. The SEO information acquisition system 1 can acquire SEO information for a query for which SEO information has not been generated in the past, thereby being able to acquire SEO information corresponding to the latest trend.

### 6-3. Third Modification

For example, a genre, an attribute, and an attribute value of an item selected from the search result page P2 in an EC service by a first user who has inputted a query in the EC service may be closely related to the query. Therefore, a classification corresponding to an action of the first user in the EC service may be acquired as a related classification.

The SEO information acquisition system 1 of a third modification includes the action information acquisition unit 504. The action information acquisition unit 504 acquires action information related to an action of a user, who has inputted a query in the EC service, after the user inputs the query. The action information is information related to an action with respect to the search result page P2 in the EC service. In the example of the embodiment, the action information is stored in the search result database DB4 and therefore, the action information acquisition unit 504 acquires the action information from the search result database DB4. The action information acquisition unit 504 may acquire the action information from databases other than the search result database DB4, computers other than the operator terminal 50, or external information storage media.

The related classification acquisition unit 502 of the third modification acquires the related classification based on the action information. For example, the related classification acquisition unit 502 acquires, as the related classification, a combination of a genre, an attribute, and an attribute value assigned to an item indicated by the action information associated with a certain query (for example, a combination of a genre, an attribute, and an attribute value of an item stored in the item database DB1) among combinations of a genre, an attribute, and an attribute value which can exist in the EC service (for example, any combination of a genre stored in the genre database DB2 and an attribute and an attribute value stored in the attribute database DB3). For example, when the first user who has inputted a certain query selects a certain item from the search result page P2, the related classification acquisition unit 502 acquires a combination of a genre, an attribute, and an attribute value assigned to the item as related classification related to the query. The processing of the SEO information acquisition after unit 503 the related classification is acquired may be the same as that in the embodiment.

Here, when a plurality of pieces of action information are associated with a certain query, the related classification acquisition unit 502 may aggregate the number of combinations of the genre, the attribute, and the attribute value assigned to the item indicated by the action information associated with the query, and acquire a combination of the genre, the attribute, and the attribute value having a relatively large aggregation number as the related classification. For example, the related classification acquisition unit 502 may acquire combinations of the genre, the attribute, and the attribute value, the aggregation number of which is ranked in the top k (k is a natural number), as the related classifications, or may acquire combinations of the genre, the attribute, and the attribute value, the aggregation number of which is equal to or greater than a threshold value, as the related classifications.

The SEO information acquisition system 1 of the third modification acquires the related classification based on the action information related to the action of a user, who has inputted a query in the EC service, after the user inputs the query. Thus, the SEO information acquisition system 1 acquires the related classification corresponding to the subsequent action of the first user who has inputted the query in the EC service, and accordingly can acquire the appropriate related classification corresponding to an actual action. As a result, the SEO information acquisition system 1 can acquire the SEO information which matches the actual usage in the EC service, thereby being able to make the SEO measures more efficient.

### 6-4. Fourth Modification

For example, although the case where a related classification corresponding to an action of a first user is acquired is exemplified in the third modification, the related classification corresponding to a score related to a query calculated by a search engine in an EC service may be acquired. The score is information indicating a connection with the query. The search engine calculates the score based on the query and an index of an item which is an example of a search target. For example, the score is calculated based on various factors such as a degree of match between the query and the index, the reliability of a page, a quality of a link, and user's feedback. A calculation method of the score may be a method employed in a known search engine.

The SEO information acquisition system 1 of a fourth modification includes the score acquisition unit 505. The score acquisition unit 505 acquires the score related to the query calculated by the search engine in the EC service. The score acquisition unit 505 acquires the score outputted from the search engine. The score is not limited to a numerical value indicating the degree of match. The search engine sometimes outputs no degree of match and therefore, the score may be a ranking obtained when the search targets are arranged in descending order of the degree of match. The score acquisition unit 505 may acquire the ranking of the search outputted by the search engine, as the score.

The related classification acquisition unit 502 of the fourth modification acquires the related classification based on the score. For example, the related classification acquisition unit 502 acquires, as the related classification, a combination of a genre, an attribute, and an attribute value assigned to an item having a relatively high score among combinations of a genre, an attribute, and an attribute value which can exist in the EC service. The related classification acquisition unit 502 may acquire, as the related classification, a combination of a genre which can exist in the EC service, a genre assigned to an item whose score is ranked in the top m (m is a natural number), an attribute, and an attribute value. The related classification acquisition unit 502 may acquire the combination of the genre, the attribute, and the attribute value assigned to an item having the score equal to or higher than a threshold value, as the related classification. The processing of the SEO information acquisition unit 503 after the related classification is acquired may be the same as that in the embodiment.

The SEO information acquisition system 1 of the fourth modification acquires the related classification based on the score related to the query calculated by the search engine in the EC service. Thus, the SEO information acquisition system 1 can acquire an appropriate related classification which trusts the score calculated by the search engine in the EC service. As a result, the SEO information acquisition system 1 can acquire the SEO information which matches the search engine in the EC service, thereby being able to make the SEO measures more efficient.

### 6-5. Fifth Modification

For example, the action information described in the third modification corresponds to a condition as to whether or not a certain classification is acquired as a related classification. Hereinafter, the condition is referred to as an acquisition condition. The score described in the fourth modification is also an example of the acquisition condition. In the SEO information acquisition system 1, a plurality of acquisition conditions may be prepared. Further, a priority order may be set for each of the plurality of acquisition conditions. In a fifth modification, the acquisition condition of the third modification is assumed to have a higher priority than t the acquisition condition of the fourth modification.

The related classification acquisition unit 502 of the fifth modification tries to acquire the related classification based on each of a plurality of conditions having a priority order, and when the related classification acquisition unit 502 acquires a plurality of related classifications, the related classification acquisition unit 502 acquires at least one related classification used for acquiring the SEO information from the plurality of related classifications, based on the priority order of each of the plurality of conditions. For example, the related classification acquisition unit 502 executes the processing of acquiring the related classification based on each of the acquisition condition of the third modification and the acquisition condition of the fourth modification. For example, when a first user who has inputted the query does not select anything from the search result page P2 or when the score of each of items searched for by a search engine is low, sometimes no related classification exists, and thus the related classification acquisition unit 502 is not always able to acquire the related classification.

For example, when the related classification acquisition unit 502 can acquire the related classification based on the acquisition condition of the third modification but cannot acquire the related classification based on the acquisition condition of the fourth modification, the priority order is not particularly referred to. In this case, the SEO information acquisition unit 503 acquires the SEO information in the same manner as in the third modification, based on the related classification acquired based on the acquisition condition of the third modification. Also when the related classification acquisition unit 502 cannot acquire the related classification based on the acquisition condition of the third modification but can acquire the related classification based on the acquisition condition of the fourth modification, the priority order is not particularly referred to. In this case, the SEO information acquisition unit 503 acquires the SEO information in the same manner as in the fourth modification, based on the related classification acquired based on the acquisition condition of the fourth modification.

For example, when the related classification acquisition unit 502 can acquire the related classification based on the acquisition condition of the third modification and can acquire the related classification based on the acquisition condition of the fourth modification, the related classification acquisition unit 502 finally acquires the related classification based on the acquisition condition of the third modification as the related classification to be used for acquiring the SEO information, in accordance with a predetermined priority order (for example, the priority of the acquisition condition of the third modification is higher than that of the acquisition condition of the fourth modification). The SEO information acquisition unit 503 acquires the SEO information in the same manner as in the third modification, based on the related classification acquired based on the acquisition condition of the third modification.

The priority order may be reversed from the above description. That is, the acquisition condition of the fourth modification may have a higher priority order than the acquisition condition of the third modification. For example, when the related classification acquisition unit 502 can acquire the related classification based on the acquisition condition of the third modification and can acquire the related classification based on the acquisition condition of the fourth modification, the related classification acquisition unit 502 finally acquires the related classification based on the acquisition condition of the fourth modification as the related classification to be used for acquiring the SEO information, in accordance with the predetermined priority order. The SEO information acquisition unit 503 acquires the SEO information in the same manner as in the fourth modification, based on the related classification acquired based on the acquisition condition of the fourth modification.

The acquisition condition is not limited to the examples of the third and fourth modifications. For example, the related classification data described in the embodiment is also an example of the acquisition condition. When the embodiment and the third and fourth modifications are combined, there are three acquisition conditions. When the related classification acquisition unit 502 acquires the related classification under all of the three acquisition conditions, the related classification acquisition unit 502 acquires the related classification acquired based on the acquisition condition having the highest predetermined priority order as the related classification to be used for acquiring the SEO information. The SEO information acquisition unit 503 acquires the SEO information based on the related classification acquired based on the acquisition condition having the highest priority order.

The SEO information acquisition system 1 of the fifth modification tries to acquire the related classification based on each of a plurality of conditions having a priority order, and when the SEO information acquisition system 1 acquires a plurality related classifications, the SEO information acquisition system 1 acquires at least one related classification used for acquiring the SEO information from the plurality of related classifications, based on the priority order of each of the plurality of conditions. Thus, the SEO information acquisition system 1 can acquire a more appropriate related classification for acquiring the SEO information. As a result, the SEO information acquisition system 1 can improve the accuracy of the SEO information.

### 6-6. Sixth Modification

For example, the classification may have a hierarchical structure as described in the embodiment. In a sixth modification, a genre will be described as an example of the classification having the hierarchical structure. The hierarchical structure is classification details. The higher the hierarchy, the more general the classification. The lower the hierarchy, the more specific the classification. For example, when the genre “fashion” is on the highest rank, there are the genres “men's fashion”, “women's fashion”, and “kids' fashion” on the lower rank of the genre “fashion”. When the genre “home appliance” is on the highest rank, there are the genres “television”, “washing machine”, and “refrigerator” on the lower rank of the genre “home appliance”.

The classification having the hierarchical structure is not limited to the genre. For example, at least one of an attribute and an attribute value may have the hierarchical structure. Classifications other than the genre, the attribute, and the attribute value, for example, may have the hierarchical structure. Hierarchical structure data indicating the hierarchical structure of the classification is assumed to be stored in advance in the data storage units 100 and 500. For example, the hierarchical structure of the genre may be defined in the genre database DB2. The hierarchical structure of at least one of the attribute and the attribute value may be defined in the attribute database DB3. The genre database DB2 and the attribute database DB3 are examples of the hierarchical structure data. As the hierarchical structure of the classification itself, various known hierarchical structures can be used.

When the related classification acquisition unit 502 of the sixth modification acquires a plurality of related classifications belonging to the classification on an upper hierarchy which is common among the plurality of related classifications, the related classification acquisition unit 502 acquires the classification on the upper hierarchy as the related classification to be used for acquiring the SEO information. For example, the related classification acquisition unit 502 tries to acquire the related classification based on the acquisition condition of at least one of the embodiment and the third and fourth modifications. When the related classification acquisition unit 502 acquires a plurality of related classifications, the related classification acquisition unit 502 determines whether or not there is a combination of related classifications having the same classification on the upper hierarchy in the plurality of related classifications, based on the hierarchical structure data.

In the above-described example, when the related classification acquisition unit 502 acquires the genres “men's fashion”, “women's fashion”, and “kids' fashion”, the related classification acquisition unit 502 determines whether or not there is the genre “fashion” on the upper hierarchy of these genres. When the related classification acquisition unit 502 acquires the genres “television”, “washing machine”, and “refrigerator”, the related classification acquisition unit 502 determines whether or not there is the genre “home appliance” on the upper hierarchy of these genres. The related classification acquisition unit 502 determines whether or not there is a genre on the upper hierarchy in the same manner for other genres. When there is the hierarchical structure in at least one of the attribute and the attribute value, the related classification acquisition unit 502 may determine whether or not there is an upper hierarchy for at least one of the attribute and the attribute value.

For example, when the related classification acquisition unit 502 determines that there is no combination of the related classifications having the same classification on the upper hierarchy, the related classification acquisition unit 502 acquires at least one of the plurality of related classifications as the related classification to be used for acquiring the SEO information. When the related classification acquisition unit 502 determines that there is the combination of the related classifications having the same classification on the upper hierarchy, the related classification acquisition unit 502 acquires the classification on the upper hierarchy of the plurality of related classifications as the related classification to be used for acquiring the SEO information. The related classification acquisition unit 502 may acquire the plurality of related classifications as the related classification to be used for acquiring the SEO information, and does not have to acquire especially the plurality of related classifications as the related classification to be used for acquiring the SEO information. The processing of the SEO information acquisition unit 503 after the related classification is acquired may be the same as that in the embodiment.

When the SEO information acquisition system 1 of the sixth modification acquires a plurality of related classifications belonging to the classification on the upper hierarchy which is common among the plurality of related classifications, the SEO information acquisition system 1 acquires the classification on the upper hierarchy as the related classification to be used for acquiring the SEO information. Thus, when the SEO information acquisition system 1 acquires a plurality of related classifications similar to each other, the SEO information acquisition system 1 can acquire the SEO information based on the classification on the upper hierarchy including the plurality of related classifications, and accordingly can respond to a wider range of queries.

### 6-7. Seventh Modification

For example, some attributes and attribute values are appropriate for a certain genre, and some attributes and attribute values are inappropriate for the genre. In the case of the genre “fashion”, the attribute and the attribute value such as “size” are appropriate, but the attribute and the attribute value such as “taste” are inappropriate. The related classification acquisition unit 502 may acquire an appropriate combination as a combination of the genre related to a search target in a predetermined service and at least one of the attribute and the attribute value related to the search target, as a related classification.

In a seventh modification, first appropriate data indicating an appropriate combination as the combination of the genre and at least one of the attribute and the attribute value related to the search target is assumed to be stored in the data storage unit 500. The first appropriate data may be in any form, for example, in a table form, in a formula form, a machine learning model, or part of a program. The first appropriate data may indicate an inappropriate combination, rather than the appropriate combination, as the combination of the genre and at least one of the attribute and the attribute value related to the search target. The first appropriate data is assumed to be prepared by an operator or another person of an EC service.

The related classification acquisition unit 502 of the seventh modification temporarily tries to acquire the related classifications based on the method described in at least one of the embodiment and the third and fourth modifications. For example, when these are acquired, the related classification acquisition unit 502 determines whether or not the combination of the genre and at least one of the attribute and the attribute value is appropriate, based on the first appropriate data. The related classification acquisition unit 502 determines whether or not the combination of the genre and at least one of the attribute and the attribute value is indicated in the first appropriate data.

For example, when the related classification acquisition unit 502 determines that the combination of the genre and at least one of the attribute and the attribute value is not indicated in the first appropriate data, the related classification acquisition unit 502 does not acquire this combination as the related classification. Thus, even if the attribute and the attribute value such as “taste” are acquired together with the genre “fashion” described above, the combination of these is excluded in accordance with the first appropriate data. When the related classification acquisition unit 502 determines that the combination of the genre and at least one of the attribute and the attribute value is indicated in the first appropriate data, the related classification acquisition unit 502 acquires this combination as the related classification. The processing of the SEO information acquisition unit 503 after the related classification is acquired may be the same as that in the embodiment.

The SEO information acquisition system 1 of the seventh modification appropriate combination as the combination of the genre related to the search target in a predetermined service and at least one of the attribute and the attribute value related to the search target, as the related classification. Thus, the SEO information acquisition system 1 can prevent the combination inappropriate as the related classification from being acquired. As a result, the SEO information acquisition system 1 can improve the accuracy of the related classification and the SEO information. For example, it is possible to prevent the inappropriate attribute and attribute value such as “taste” from being embedded as the SEO information together with the genre “fashion”.

### 6-8. Eighth Modification

For example, the combination of the genre and at least one of the attribute and the attribute value is exemplified in the seventh modification, but some combinations of a query and at least one of a genre, an attribute, and an attribute value are appropriate, and some combinations are inappropriate. In the case of the query “BBB sports T-shirt” described in the embodiment, the genre such as “fashion” and the attribute and the attribute value such as “size” are appropriate, but the genre such as “food” and the attribute and the attribute value such as “taste” are inappropriate. The related classification acquisition unit 502 may acquire a classification appropriate as the combination with the query, as a related classification.

In an eighth modification, second appropriate data indicating an appropriate combination of the query and at least one of the genre, the attribute, and the attribute value related to a search target is assumed to be stored in the data storage unit 500. The second appropriate data may be in any form, for example, in a table form, in a formula form, a machine learning model, or part of a program. The second appropriate data may indicate an inappropriate combination as the combination of the query and at least one of the genre, the attribute, and the attribute value related to the search target. The second appropriate data is assumed to be prepared by an operator or another person of an EC service.

The related classification acquisition unit 502 of the eighth modification temporarily tries to acquire the related classifications based on the method described in at least one of the embodiment and the third and fourth modifications. For example, when these are acquired, the related classification acquisition unit 502 determines whether or not the combination of the query and at least one of the genre, the attribute, and the attribute value is appropriate, based on the second appropriate data. The related classification acquisition unit 502 determines whether or not the combination of the query and at least one of the genre, the attribute, and the attribute value is indicated in the second appropriate data.

For example, when the related classification acquisition unit 502 determines that the combination of the query and at least one of the genre, the attribute, and the attribute value is not indicated in the second appropriate data, the related classification acquisition unit 502 does not acquire at least one of the genre, the attribute, and the attribute value as the related classification. Thus, even if the genre such as “food” and the attribute and the attribute value such as “taste” are acquired together with the query “BBB sports T-shirt” described above, the combination of these is excluded in accordance with the second appropriate data. When the related classification acquisition unit 502 determines that the combination of the query and at least one of the genre, the attribute, and the attribute value is indicated in the second appropriate data, the related classification acquisition unit 502 acquires at least one of the genre, the attribute, and the attribute value as the related classification. The processing of the SEO information acquisition unit 503 after the related classification is acquired may be the same as that in the embodiment.

The SEO information acquisition system 1 of the eighth modification acquires the classification appropriate as the combination with the query, as the related classification. Thus, the SEO information acquisition system 1 can prevent the classification inappropriate as the related classification from being acquired as the related classification. As a result, the SEO information acquisition system 1 can improve the accuracy of the related classification and the SEO information. For example, it is possible to prevent the inappropriate genre, attribute, and attribute value, for example, the genre such as “food” and the attribute and the attribute value such as “taste”, from being embedded as the SEO information together with the query “BBB sports T-shirt”.

### 6-9. Ninth Modification

As the eighth modification provides some description, for example, the related classification acquisition unit 502 may acquire a genre which is related to a search target in a predetermined service and is appropriate as a combination with a query, as a related classification. In a ninth modification, third appropriate data indicating an appropriate combination as the combination of the query and the genre is assumed to be stored in the data storage unit 500. The third appropriate data may be in any form, for example, in a table form, in a formula form, a machine learning model, or part of a program. The third appropriate data may indicate an inappropriate combination, rather than the appropriate combination, as the combination of the query and the genre. The third appropriate data is assumed to be prepared by an operator or another person of an EC service.

The related classification acquisition unit 502 of the ninth modification temporarily tries to acquire the genre, which is an example of the related classification, based on the method described in at least one of the embodiment and the third and fourth modifications. For example, the related classification acquisition unit 502 determines whether or not the combination of the query and the genre is appropriate, based on the third appropriate data. The related classification acquisition unit 502 determines whether or not the combination of the query and the genre is indicated in the third appropriate data.

For example, when the related classification acquisition unit 502 determines that the combination of the query and the genre is not indicated in the third appropriate data, the related classification acquisition unit 502 does not acquire this genre as the related classification. Thus, even if the genre such as “food” is acquired together with the query “BBB sports T-shirt”, the combination of these is excluded in accordance with the third appropriate data. When the related classification acquisition unit 502 determines that the combination of the query and the genre is indicated in the third appropriate data, the related classification acquisition unit 502 acquires this genre as the related classification. The processing of the SEO information acquisition unit 503 after the related classification is acquired may be the same as that in the embodiment.

The SEO information acquisition system 1 of the ninth modification acquires the genre which is related to the search target in the EC service and is appropriate as the combination with the query, as the related classification. Thus, the SEO information acquisition system 1 can prevent the classification inappropriate as the related classification from being acquired as the related classification. As a result, the SEO information acquisition system 1 can improve the accuracy of the related classification and the SEO information. For example, it is possible to prevent the inappropriate genre such as “food” from being embedded as the SEO information together with the query “BBB sports T-shirt”.

### 6-10. Tenth Modification

For example, the related classification acquisition unit 502 acquires at least one of an attribute and an attribute value which is related to a search target in a predetermined service and is appropriate as a combination with a query, as a related classification. In a tenth modification, fourth appropriate data indicating an appropriate combination as the combination of the query and at least one of the attribute and the attribute value is assumed to be stored in the data storage unit 500. The fourth appropriate data may be in any form, for example, in a table form, in a formula form, a machine learning model, or part of a program. The fourth appropriate data may indicate an inappropriate combination, rather than the appropriate combination, as the combination of the query and at least one of the attribute and the attribute value. The fourth appropriate data is assumed to be prepared by an operator or another person of an EC service.

The related classification acquisition unit 502 of the tenth modification temporarily tries to acquire at least one of the attribute and the attribute value, which are examples of the related classification, based on the method described in at least one of the embodiment and the third and fourth modifications. For example, the related classification acquisition unit 502 determines whether or not the combination of the query and at least one of the attribute and the attribute value is appropriate, based on the fourth appropriate data. The related classification acquisition unit 502 determines whether or not the combination of the query and at least one of the attribute and the attribute value is indicated in the fourth appropriate data.

For example, when the related classification acquisition unit 502 determines that the combination of the query and at least one of the attribute and the attribute value is not indicated in the fourth appropriate data, the related classification acquisition unit 502 does not acquire at least one of this attribute and this attribute value as the related classification. Thus, even if at least one of the attribute and the attribute value such as “taste” is acquired together with the query “BBB sports T-shirt”, the combination of these is excluded in accordance with the fourth appropriate data. When the related classification acquisition unit 502 determines that the combination of the query and at least one of the attribute and the attribute value is indicated in the fourth appropriate data, the related classification acquisition unit 502 acquires at least one of this attribute and this attribute value as the related classification. The processing of the SEO information acquisition unit 503 after the related classification is acquired may be the same as that in the embodiment.

The SEO information acquisition system 1 of the tenth modification acquires at least one of the attribute and the attribute value which is related to the search target in the predetermined service and is appropriate as the combination with the query, as the related classification. Thus, the SEO information acquisition system 1 can prevent at least one of the attribute and the attribute value inappropriate as the related classification from being acquired as the related classification. As a result, the SEO information acquisition system 1 can improve the accuracy of the related classification and the SEO information. For example, it is possible to prevent the inappropriate attribute and attribute value such as “taste” from being embedded as the SEO information together with the query “BBB sports T-shirt”.

### 6-11. Eleventh Modification

For example, if a query is “BBB sports fashion”, the query includes a genre “fashion”. If the query is “BBB sports color”, the query includes an attribute “color”. Such a query is closely related to at least one of the genre, attribute, and attribute value included in the query and therefore, the query may become noise when at least one of another genre, attribute, and attribute value is acquired as a related classification. Therefore, when a classification related to a search target in an EC service is included in the query, the related classification acquisition unit 502 may acquire the classification included in the query as the related classification without acquiring another classification as the related classification. That is, when the query already includes the classification, the related classification acquisition unit 502 directly acquires the classification included in the query as the related classification without executing the processing of acquiring the related classification by the method of at least one of the embodiment and the third and fourth modifications.

For example, the related classification acquisition unit 502 determines whether or not the genre is already included in the query acquired by the query acquisition unit 501, based on the genre database DB2. When the related classification acquisition unit 502 does not determine that the genre is already included in the query acquired by the query acquisition unit 501 based on the genre database DB2, the related classification acquisition unit 502 acquires the genre in the same manner as the method described in the embodiment. When the related classification acquisition unit 502 determines that the genre is already included in the query acquired by the query acquisition unit 501 based on the genre database DB2, the related classification acquisition unit 502 acquires the genre included in the query without acquiring the genre by the method described in the embodiment.

For example, the related classification acquisition unit 502 determines whether or not at least one of the attribute and the attribute value is already included in the query obtained by the query acquisition unit 501, based on the attribute database DB3. When the related classification acquisition unit 502 does not determine that at least one of the attribute and the attribute value is already included in the query acquired by the query acquisition unit 501 based on the attribute database DB3, the related classification acquisition unit 502 acquires at least one of the attribute and the attribute value in the same manner as the method described in the embodiment. When the related classification acquisition unit 502 determines that at least one of the attribute and the attribute value is already included in the query acquired by the query acquisition unit 501 based on the attribute database DB3, the related classification acquisition unit 502 acquires at least one of the attribute and the attribute value included in the query without acquiring at least one of the attribute and the attribute value by the method described in the embodiment.

When the classification related to the search target in the predetermined service is included in the query, the SEO information acquisition system 1 of an eleventh modification acquires the classification included in the query as the related classification without acquiring another classification as the related classification. Accordingly, the SEO information acquisition system 1 can directly acquire the classification which is included in the query and is closely related to the query as the related classification. As a result, the SEO information acquisition system 1 can improve the accuracy of the related classification and the SEO information.

### 6-12. Twelfth Modification

For example, the case where an operator or another person in an EC service prepares a template of SEO information is exemplified in the embodiment, but the template of the SEO information may be generated by a generation AI. Any arbitrary AI may be used as the generation AI. In a twelfth modification, a case where a large-scale language model such as GPT is the generation AI will be described as an example. However, the generation AI may be a machine learning model (for example, a neural network or a GAN) which is not particularly classified as the large-scale language model. The generation AI may be stored in the data storage unit 500, but in the twelfth modification, the generation AI is assumed to be stored in an external system which cooperates with the SEO information generation system 1.

The SEO information acquisition system 1 of the twelfth modification includes the template generation unit 506. The template generation unit 506 causes the generation AI to generate the template which is related to the SEO information and corresponds to a classification. For example, the template generation unit 506 inputs the classification into the generation AI for each classification. The generation AI calculates an embedded representation of the classification inputted into the generation AI itself (information indicating a feature of a character string indicating the classification, for example, a multidimensional vector), and outputs at least a part 41 of the template corresponding to the embedded representation. For example, the generation AI may output a text of a description indicating the meaning of the classification as at least a part of the template.

For example, the template generation unit 506 acquires an arbitrary number of combinations of a genre, an attribute, and an attribute value to be used as the classification, from the genre database DB2 and the attribute database DB3. The template generation unit 506 inputs each of the plurality of classifications into the generation AI and acquires at least a part of the template outputted from the generation AI. The template generation unit 506 acquires at least a part of the template outputted from the generation AI into which the classifications are inputted, for each of the classifications.

For example, the template generation unit 506 may input, into the generation AI, a default prompt indicating that the template of the SEO information is to be generated based on the classification, such as: “You are an AI that generates a template of SEO information. Generate a template corresponding to a classification inputted to you.” The default prompt is assumed to be stored in the data storage unit 500. The template generation unit 506 inputs the default prompt and the classification into the generation AI. The generation AI can recognize what data it needs to generate, based on the default prompt.

For example, the template generation unit 506 records the classification inputted into the generation AI and the template generated by the generation AI in the data storage unit 500 in a manner to associate the classification and the template with each other. The SEO information acquisition unit 503 of the twelfth modification refers to the association of these (for example, a template database in which the template for each classification is stored) so as to acquire the SEO information based on template corresponding to the related the classification. The SEO information acquisition unit 503 uses the template corresponding to the related classification among the templates stored in the data storage unit 500 to acquire the SEO information. The process of acquiring the SEO information based on the template may be the same as that in the embodiment. The SEO information acquisition system 1 of the twelfth modification causes the generation AI to generate the template which is related to the SEO information and corresponds to the classification. The SEO information acquisition system 1 acquires the SEO information based on the template corresponding to the related classification. Thus, the SEO information acquisition system 1 can eliminate the need to generate templates. The SEO information acquisition system 1 can acquire the SEO information based on the appropriate template corresponding to the classification, and thus can improve the accuracy of the SEO information.

### 6-13. Thirteenth Modification

For example, in the twelfth modification, the template generation unit 506 may generate a template including a first portion generated by the generation AI and a second portion not generated by the generation AI. The first portion is an output from the generating AI. A thirteenth modification describes a case where an explanation of a classification is the first portion, as an example. For example, the generation AI outputs the meaning of at least one word of a genre, an attribute, and an attribute value. The template generation unit 506 acquires the meanings of these words outputted from the generation AI as the first portion.

The second portion is generated by an operator or another person. In the thirteenth modification, the case where the template of FIG. 4 is the second portion is described as an example, but the second portion may have any content. For example, the second portion may include at least one of the genre, the attribute, and the attribute value, or may be free from including these. The second portion may be common to a plurality of classifications or may be generated for each classification. Second portion data indicating the second portion is assumed to be stored in the data storage unit 500.

For example, the template generation unit 506 combines the first portion generated by the generation AI based on a corresponding classification and the second portion indicated by the second portion data for each classification so as to generate a template of the corresponding classification. When the template of FIG. 4 corresponds to the second portion, the template generation unit 506 generates, as the template, a character string obtained by combining the meaning of at least one word of the genre, the attribute, and the attribute value outputted from the generation AI and the second portion in which the at least one of them is embedded. The template may include a portion other than the first portion and the second portion.

The SEO information acquisition unit 503 of the thirteenth modification acquires the SEO information by embedding the related classification in the second portion. The SEO information acquisition unit 503 uses the template corresponding to the related classification among the templates stored in the data storage unit 500 to acquire the SEO information. The processing at the time of using the template may be the same as that in the embodiment and the first to twelfth modifications.

The SEO information acquisition system 1 of the thirteenth modification generates the template including the first portion generated by the generation AI and the second portion not generated by the generation AI, and the SEO information acquisition system 1 acquires the SEO information by embedding the related classification in the second portion. Thus, the SEO information acquisition system 1 can further improve the accuracy of the SEO information by using the template in which the first portion which is appropriately outputted by the generation AI and the second portion which is not appropriately outputted are combined.

### 6-14. Other Modifications

For example, the above-described modifications may be combined.

For example, the functions described as being implemented by the operator terminal 50 may be implemented by another computer such as the EC server 10. The functions described as being implemented by the operator terminal 50 may be shared by a plurality of computers. The functions described as being implemented by the EC server 10 may be implemented by another computer such as the operator terminal 50.

What is claimed is:

1. An SEO information acquisition system comprising at least one processor configured to:
acquire a query used for a search in a predetermined service;
acquire a related classification, the related classification being a classification used for a search in the predetermined service and being the classification related to the query; and
acquire SEO information on SEO (Search Engine Optimization) of a search result page corresponding to the query in the predetermined service, based on the related classification.

2. The SEO information acquisition system according to claim 1, wherein the at least one processor is configured to acquire the query having a relatively large number of searches in the predetermined service.

3. The SEO information acquisition system according to claim 1, wherein when a certain acquisition timing arrives, the at least one processor is not configured to acquire the SEO information of the query the SEO information of which is acquired at least at a previous acquisition timing and is configured to acquire the SEO information of the query the SEO information of which is not acquired at least at the previous acquisition timing.

4. The SEO information acquisition system according to claim 1, wherein the at least one processor is configured to:
acquire action information on an action of a user after the user inputs the query, the user inputting the query in the predetermined service, and
acquire the related classification based on the action information.

5. The SEO information acquisition system according to claim 1, wherein the at least one processor is configured to:
acquire a score related to the query calculated by a search engine in the predetermined service, and
acquire the related classification based on the score.

6. The SEO information acquisition system according to claim 1, wherein:
the at least one processor is configured to try to acquire the related classification based on each of a plurality of conditions having a priority order, and
when the at least one processor acquires a plurality of the related classifications, the at least one processor is configured to acquire at least one of the related classifications used for acquiring the SEO information from among the plurality of related classifications, based on the priority order of each of the plurality of conditions.

7. The SEO information acquisition system according to claim 1, wherein:
the classification has a hierarchical structure, and
when the at least one processor is configured to acquire a plurality of the related classifications belonging to the classification on an upper hierarchy which is common among the plurality of related classifications, the at least one processor is configured to acquire the classification on the upper hierarchy as the related classification used for acquisition of the SEO information.

8. The SEO information acquisition system according to claim 1, wherein the at least one processor is configured to acquire an appropriate combination as a combination of a genre related to a search target in the predetermined service and at least one of an attribute and an attribute value related to the search target, as the related classification.

9. The SEO information acquisition system according to claim 1, wherein the at least one processor is configured to acquire the classification appropriate as a combination with the query, as the related classification.

10. The SEO information acquisition system according to claim 9, wherein the at least one processor is configured to acquire a genre related to a search target in the predetermined service, the genre being appropriate as a combination with the query, as the related classification.

11. The SEO information acquisition system according to claim 9, wherein the at least one processor is configured to acquire at least one of an attribute and an attribute value related to a search target in the predetermined service, the at least one of the attribute and the attribute value being appropriate as a combination with the query, as the related classification.

12. The SEO information acquisition system according to claim 1, wherein when the classification related to a search target in the predetermined service is included in the query, the at least one processor is configured to acquire the classification included in the query as the related classification without acquiring another classification as the related classification.

13. The SEO information acquisition system according to claim 1, wherein the at least one processor is configured to:
cause a generation AI to generate a template related to the SEO information, the template corresponding to the classification, and
acquire the SEO information based on the template corresponding to the related classification.

14. The SEO information acquisition system according to claim 13, wherein the at least one processor is configured to:
generate the template including a first portion generated by the generation AI and a second portion not generated by the generation AI, and
acquire the SEO information by embedding the related classification in the second portion.

15. An SEO information acquisition method comprising:
acquiring a query used for a search in a predetermined service;
acquiring a related classification, the related classification being a classification used for a search in the predetermined service and being the classification related to the query; and
acquiring SEO information on SEO (Search Engine Optimization) of a search result page corresponding to the query in the predetermined service, based on the related classification.

16. A non-transitory computer readable information storage medium storing a program that causes a computer to:
acquire a query used for a search in a predetermined service;
acquire a related classification, the related classification being a classification used for a search in the predetermined service and being the classification related to the query; and
acquire SEO information on SEO (Search Engine Optimization) of a search result page corresponding to the query in the predetermined service, based on the related classification.
